(19) United States
(12) Patent Application Publication
(10) Pub. No.: US 2005/0062298 A1
(43) Pub. Date: Mar. 24, 2005

(54) Frame-shaped supporting element for a motor vehicle which closed on one side by web-shaped cover

(76) Inventors: Mario Glashagel, Friolzheim (DE); Volker Kauffmann, Renningen (DE); Uwe Krempels, Boblingen (DE); Walter Nuber, Goppingen (DE); Holger Schimd, Horb (DE)

Correspondence Address: CROWELL & MORING LLP;INTELLECTUAL PROPERTY GROUP, P.O. BOX 14300, WASHINGTON, DC, 20044-4300, US

(21) Appl. No.: 10/494,958

(22) PCT Filed: Oct. 29, 2002
(86) PCT No.: PCT/EP02/12051

(30) Foreign Application Priority Data
Nov. 10, 2001 (DE) 101 55 341.2

(51) Int. Cl. B60R 19/02

(52) U.S. Cl. 293/102

(57) ABSTRACT

In a frame-shaped supporting element of a motor vehicle for supporting a bumper containing energy-absorbing material, in particular a U-shaped profile which is attached to longitudinal beams of the vehicle, having the longitudinal edges of the limbs of the U-shaped profile and possibly reinforcement webs provided within the U-shaped profile as frame parts, whose free space which is enclosed by the frame faces the bumper, and is permanently closed over the frame edges, adjoining the adjoining bumper, with a ribbon-shaped cover which faces the absorbent material of the bumper, the resistance of the ribbon-shaped cover to plastic deformation in the event of a crash is to be increased without increasing the weight of the cover. For this purpose, such a transverse beam is characterized in that the ribbon-shaped cover is of concave configuration at least between some of the individual frame edges opposite the adjoining bumper over the respective entire frame free space lying between these frame edges.

The invention relates to a frame-shaped supporting element, permanently closed on one side with a ribbon-shaped cover, of a motor vehicle according to the preamble of the patent claim.

The invention is concerned with the problem of avoiding, in the event of a crash, the ribbon-shaped cover of the frame-shaped supporting part against plastic deformation by forces exerted on the cover by the bumper, up to the highest possible upper limiting value of the impact energy, accompanied by a configuration of the cover which is as lightweight as possible.

This problem is solved by the configuration of a transverse member of the generic type, according to the characterizing features of patent claim 1.

The invention is based on the general idea of using the concave shape of the ribbon-shaped cover between its supporting regions to absorb the greatest possible proportion of the impact energy due to tensile forces generated within the ribbon-shaped cover. As a result, the degree of impact energy at which the ribbon-shaped cover is still not plastically deformed is increased considerably in comparison with a planar configuration of the ribbon-shaped cover in which a considerably higher proportion of bending stress occurs when the impact energy is absorbed.

A shape which is in particular continuously concave over the entire free space lying between the frame edges is of particular importance for achieving the effect according to the invention.

One advantageous exemplary embodiment, to which the invention is however not restricted, is illustrated in the drawing.

In the drawing, the single

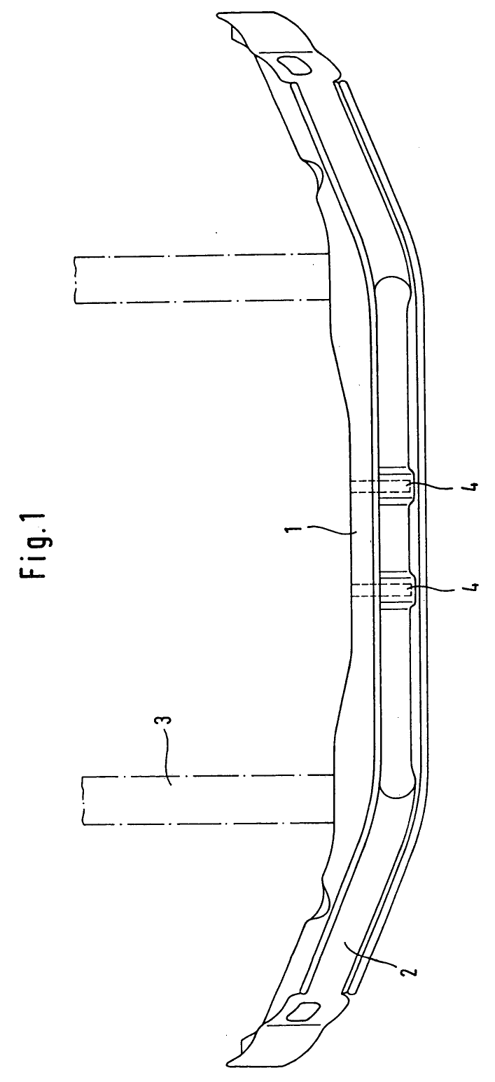

FIG. 1 shows a perspective view of a U-shaped profile, covered with a ribbon-shaped cover, of a vehicle transverse beam.

A vehicle transverse beam as a frame-shaped supporting element in the sense of the invention is composed of a U-shaped profile 1 with a ribbon-shaped cover 2 which covers the open side of the profile. When these two parts are constructed from metal, they are welded to one another.

The U-shaped profile 1 is permanently attached to two longitudinal beams 3 of the motor vehicle.

Reinforcing webs 4 which each extend between the U-shaped limbs of the U-shaped profile 1 and meet the base of U-shaped profile 1 at a right angle are provided within the U-shaped profile, in the region between the longitudinal beams 2. For the rest, these beams extend up to the free ends of the U-shaped limbs of the U-shaped profile 1.

A bumper (not illustrated in the drawing) of the motor vehicle bears with its elastically deformable material region against the ribbon-shaped cover 2. In the region between the longitudinal beams 3, the ribbon-shaped cover 2 is retracted inwards in a concave shape when viewed from the outside, there being in total three such regions, two of which start directly at the regions of attachment to the longitudinal beams 3 and each end at one of the webs 4, and the third region of which is provided between the webs 4.

Trials have shown that a considerably higher upper impact energy limiting value at which the cover is not yet plastically deformed can be achieved with the shaping of the cover 2 described above as opposed to a configuration with a planar profile of this cover 2. This is a large advantage which can be achieved with the invention.

1. A frame-shaped supporting element of a motor vehicle for supporting a bumper containing energy-absorbing material, having a U-shaped profile, which is attached in particular to longitudinal beams of the vehicle, having the longitudinal edges of the limbs of the U-shaped profile as frame parts, whose free space which is enclosed by the frame parts faces the bumper and which is permanently closed over the frame edges, adjoining the adjoining bumper, with a ribbon-shaped cover which faces the absorbent material of the bumper, the ribbon-shaped cover being of concave configuration between the frame edges opposite the adjoining bumper over the entire frame free space lying between these frame edges, characterized by the features
reinforcing webs (4) which occur in the longitudinal direction of the U-shaped profile (1), each spaced apart between its U-limbs perpendicularly on the base of the U-shaped profile (1), are provided within the U-shaped profile (1),
the reinforcing webs (4) form additional frame edges, permanently connected to the ribbon-shaped cover, of the frame-shaped supporting element.
